(19) United States
(12) Patent Application Publication
(10) Pub. No.: US 2004/0189853 A1
(43) Pub. Date: Sep. 30, 2004

(54) Camera module

(76) Inventors: Takashi Takeuchi, Ibaraki-shi (JP); Kiyoharu Kishimoto, Ibaraki-shi (JP); Shuuzou Matsumoto, Ibaraki-shi (JP)

Correspondence Address: BIRCH STEWART KOLASCH & BIRCH, PO BOX 747, FALLS CHURCH, VA, 22040-0747, US

(21) Appl. No.: 10/483,389

(22) PCT Filed: Jul. 25, 2002
(86) PCT No.: PCT/JP02/07556

(30) Foreign Application Priority Data
Aug. 7, 2001 (JP) 2001-238568

(51) Int. Cl. H04N 5/225

(52) U.S. Cl. 348/340

(57) ABSTRACT

A camera module includes a lens 11, an optical tube 12 for supporting the lens 1, and an image sensor chip 2 for outputting image signals based on the light coming through the lens 11. The optical tube 12 is attached to the image sensor chip 2. The image sensor chip 2 has a sensor portion 21 and a logic circuit portion 22 on one surface thereof, and the optical tube 12 is attached to the logic circuit portion 22. In this structure, a camera module can be downsized and achieve high focus accuracy.

### TECHNICAL FIELD

The present invention relates to a camera module, and more specifically, to a camera module including a lens, a lens supporting structure for supporting the lens, and an image sensor chip.

### BACKGROUND ART

Camera modules are widely used for mobile phones, personal digital assistants (PDAs), and card cameras. An example of the structure of a conventional camera module is shown in FIG. 8. As shown therein, a package 108 containing an image sensor chip 106 is mounted and attached to a substrate 104 by solder 103. At the top of the package 108 is placed a cover glass 105, which allows light to enter from above.

The package 108 is surrounded by an optical tube 102 that supports a lens 101. The optical tube 102 serves as a lens supporting structure. The optical tube 102 is cylindrical shaped and is composed of two members. The two members of the optical tube 102 are relatively movable to adjust the distance between the lens 101 and the image sensor chip 106 for focusing.

With downsizing of mobile phones and so on, camera modules used therefor face the requirement for further scale reduction. However, having a structure as shown in FIG. 8, the conventional camera modules are difficult to achieve downscaling.

Besides, the conventional camera module has many structures to determine the path length between the lens 101 and the image sensor chip 106: the lens 101, the two members of the optical tube 102, the substrate 104, the package 108, and the image sensor chip 106. This structure accumulates errors in structure size and errors in connection of those structures. This causes significant variation in the path length between the lens 101 and the image sensor chip 106 to lower focus accuracy.

As described above, the conventional camera modules are difficult to meet the requirement for downsizing and have a problem of low focus accuracy.

Accordingly, an object of the present invention is to provide a camera module having a reduced size and achieving high focus accuracy.

### DISCLOSURE OF THE INVENTION

A camera module according to the present invention includes a lens unit having a lens and a lens supporting structure for supporting the lens, and an image sensor chip for processing image signals based on light coming through the lens. The lens unit is attached to the image sensor chip. This configuration allows achieving downsizing and high focus accuracy.

It is preferred that the image sensor chip has a sensor portion and a logic circuit portion on one surface thereof, and the lens unit is attached to the logic circuit portion. This configuration allows effective use of the space above the logic circuit portion.

The camera module may have a chip size package rewiring layer in a part different from the sensor portion.

The camera module may further include a wiring substrate having a window portion, and the lens unit may be attached to the wiring substrate in such a way of being inserted into the window portion of the wiring substrate. This configuration allows downsizing including the wiring substrate.

The image sensor chip and the wiring substrate may be electrically connected by a solder bump or by anisotropic conductive material.

### BRIEF DESCRIPTION OF THE DRAWINGS

FIG. 1 is a block diagram of a camera module according to an embodiment of the present invention.

FIG. 2 is a block diagram of a camera module according to an embodiment of the present invention.

FIG. 3 is a perspective view of a camera module according to an embodiment of the present invention.

FIG. 4 is a block diagram of a camera module according to an embodiment of the present invention.

FIG. 5 is a block diagram of a camera module according to an embodiment of the present invention.

FIG. 6 is a block diagram of a camera module according to an embodiment of the present invention.

FIG. 7 is a cross-sectional view showing a part of a camera module according to an embodiment of the present invention.

FIG. 8 is a block diagram of a conventional camera module.

### BEST MODES FOR CARRYING OUT THE INVENTION

Embodiment 1

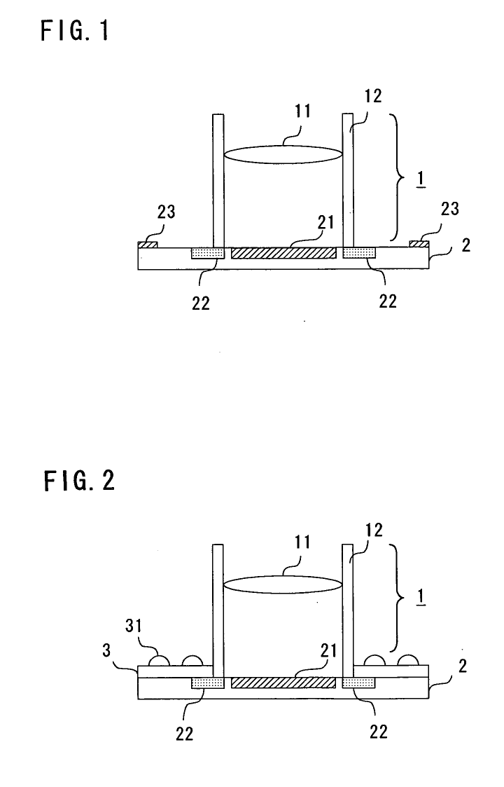

FIG. 1 is a block diagram showing a main part of a camera module according to the first embodiment of the present invention. The camera module includes a lens unit 1 and an image sensor chip 2. The lens unit 1 is composed of a lens 11 and an optical tube 12. The lens 11, which is an aspherical convex lens in this example, focuses incoming light on the surface of the image sensor chip 2. The lens 11 is made of plastic or glass, for example. The lens unit 1 may have a plurality of the lenses 11 placed on an optical path.

The optical tube 12 has a cylindrical or polygonal shape, for example, and supports the lens 11 at a certain position of its inner surface. The optical tube 12 serves as a lens supporting structure, and it is not necessarily tube-shaped. For example, it may support the lens 11 at one or more points.

The image sensor chip 2 has a sensor portion 21, a logic circuit portion 22, and a bonding pad 23. The sensor portion 21 is formed on the surface of the image sensor chip 2. The sensor portion 21 is an element that converts optical information into electrical signals and outputs them as image signals. The element has multiple read-out pixels. The image sensor chip 2 does not have to output image signals themselves but just to process image signals according to light coming through the lens 11. For example, the image sensor chip 2 may be a structure that identifies changes in images by comparing image signals to predetermined signals or to image signals obtained by past photographing, and then outputs signals indicating whether there has been a change or not.

The sensor portion 21 is CCD element or CMOS element, for example. The logic circuit portion 22 performs various signal processing such as amplification and noise reduction on the electrical signals outputted from the sensor portion 21. The bonding pad 23 is an input/output terminal electrically connected to the logic circuit portion 22. The bonding pad 23 is electrically connected also to an external electrode by wire bonding. An example is placing the image sensor 2 on a wiring substrate constituting a mobile phone, PDA, or card camera, and electrically connecting the bonding pad 23 and the wiring substrate by wire bonding. It is also possible to place the image sensor 2 on a sub wiring substrate on which passive parts such as a resistor and a capacitor and active parts such as a transistor and a LSI are mounted, then electrically connect the bonding pad 23 and the sub wiring substrate by wire bonding, and electrically connect the sub wiring substrate to a mobile phone, PDA, or card camera.

The optical tube 12 is securely mounted on the logic circuit portion 22 of the image sensor chip 2. The optical tube 12 and the image sensor chip 2 are attached together by ultraviolet curable resin, for example. In this case, the optical tube 12 is previously placed at a predetermined position on the image sensor chip 2, and then the ultraviolet curable resin is applied so as to attach the image sensor chip 2 and the optical tube 12 together. Alternatively, it is also possible to apply the ultraviolet curable resin to either or both of the image sensor chip 2 and the optical tube 12, and then fix their position. After that, the ultraviolet curable resin is exposed to ultraviolet light, thereby attaching the image sensor chip 2 and the optical tube 12 together.

By placing the optical tube 12 on the logic circuit portion 22, it allows effective use of the space above the logic circuit portion 22 which is generally in disuse. Especially, since it will be increasingly common to place the sensor portion 21 and the logic circuit portion 22 in one chip, the technique of utilizing the space above the logic circuit portion 22 is valuable.

As described above, the camera module shown in FIG. 1 has a structure that directly mounts the lens supporting structure on the image sensor chip, thereby achieving downsizing. Further, since between the lens and the image sensor chip is the lens supporting structure only, accumulated errors are small; therefore, the relative position of the lens and the image sensor chip can be accurately fixed.

Embodiment 2

The structure of a camera module according to the second embodiment of this invention will be explained hereinafter with reference to FIG. 2. The structure shown in FIG. 2 has a CSP (Chip Size Package) rewiring layer 3. The CSP rewiring layer 3 has an optical window where the optical tube 12 is attached to the image sensor chip 2. On the CSP rewiring layer 3 are formed a plurality of solder bumps 31. The solder bumps 31 are electrically connected to the logic circuit portion 22 formed on the image sensor chip 2 by rewired lines such as a copper line. The rewiring line allows connecting the bumps 31 and an input/output terminal of the logic circuit portion 22, and placing the bumps 31 on the chip. The bumps 31 for substrate connection can be thereby placed on the entire upper surface of the chip including the logic circuit portion 22 though the pads 23 are placed only on the periphery of the chip in the structure shown in FIG. 1.

The camera module shown in FIG. 2 has a structure that directly mounts the optical tube on the image sensor chip like the one shown in FIG. 1, thereby achieving downsizing. Further, since between the lens and the image sensor chip is the lens supporting structure only, accumulated errors are small; therefore, the relative position of the lens and the image sensor chip can be accurately fixed.

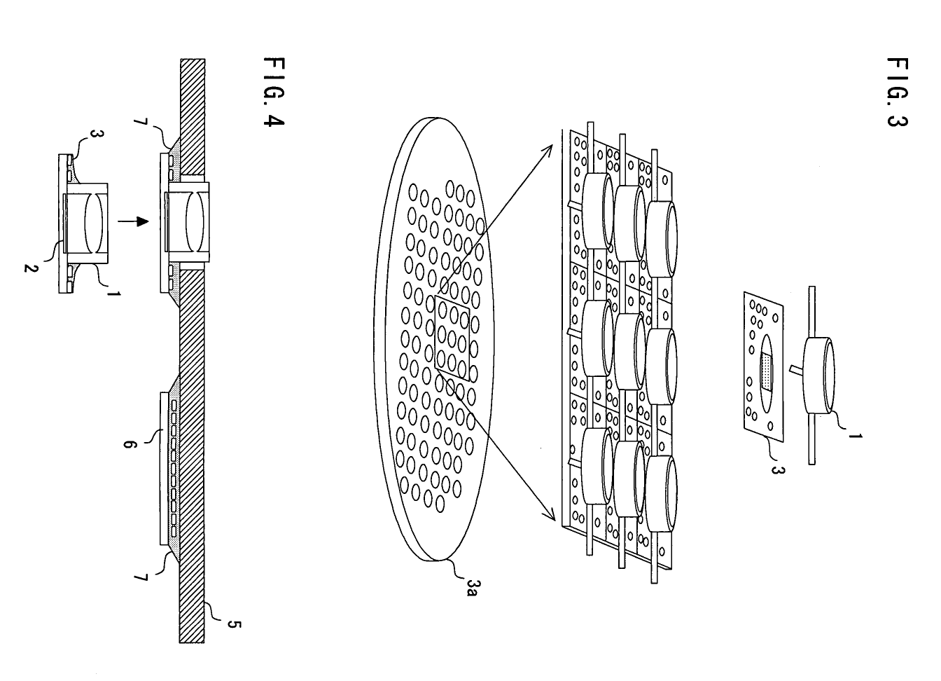

The camera module according to the second embodiment of the invention will be further explained with reference to FIG. 3. The process of composing the camera module is performed at the wafer level. The optical tube 12 to support the lens 11 is attached to a wafer 3a before the wafer is diced into chip size pieces. A robot is used for the attachment so as to place the optical tube 12 at an exact position on the wafer 3a and to reduce the impact of contact. After that, the wafer 3a is diced into chip size pieces.

Embodiment 3

The structure of a camera module according to the third embodiment of the present invention is shown in FIG. 4. The camera module according to the third embodiment of the invention has the lens unit 21 and the image sensor chip 2, and further has a multilayer wiring substrate 5. The wiring substrate 5 is, for example, made of polyester or polyimide and is wired with copper. The wiring substrate 5 in this embodiment has a window portion.

The camera module having the same structure as in the second embodiment is fixed to the wiring substrate 5 by underfill 7 with the optical tube 12 inserted into the substrate window portion. The underfill 7 is a resin sealant.

In the vicinity of the window portion of the wiring substrate 5 are formed external electrodes in the positions corresponding to the solder bumps 31 on the CSP rewiring layer 3. The camera module according to the second embodiment is inserted into the window portion of the wiring substrate 5, and the solder bumps 31 and the external electrodes of the wiring substrate 5 are electrically connected by heat treatment and so on.

On the wiring substrate 5 is also mounted another chip such as a DSP (Digital Signal Processor) chip 6 at the surface having the external electrodes. The DSP chip 6 is attached to the wiring substrate 5 with the underfill 7.

As described in the foregoing, the camera module according to the third embodiment has a structure where the lens unit is inserted into the window portion of the wiring substrate, thereby achieving further downsizing. In addition, if the structure is configured so that the outer surface of the lens supporting structure or the optical tube contacts the inner surface of the window portion of the wiring substrate, their relative positions can be mutually restricted, allowing easier position determination

Embodiment 4

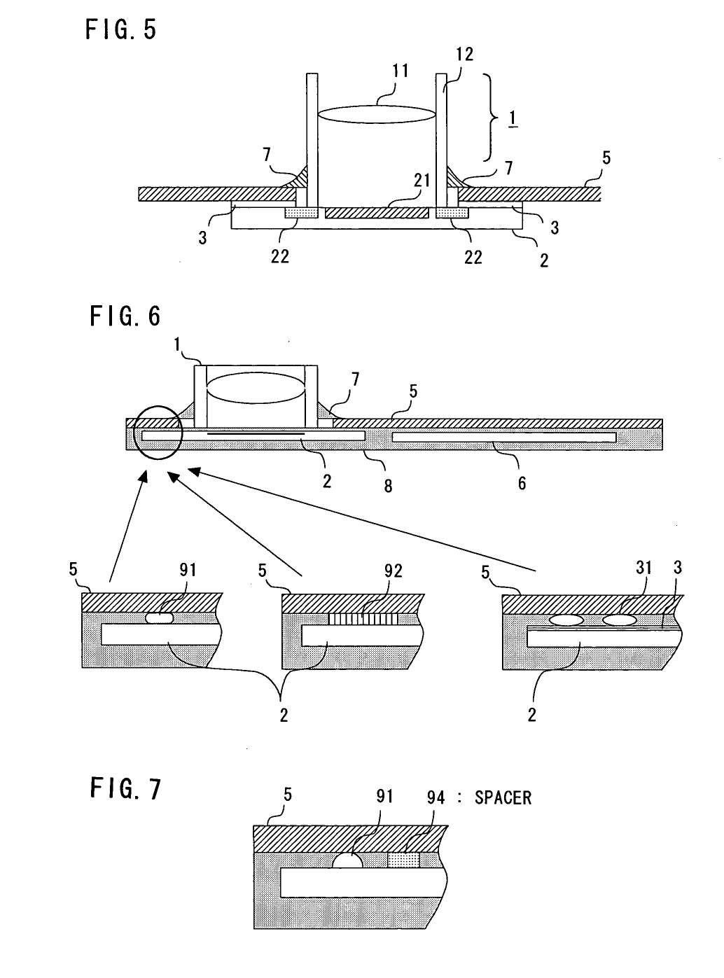

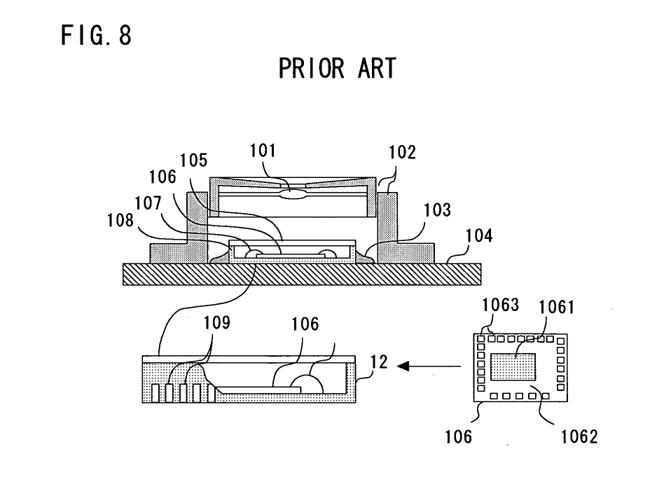

The structure of the camera module according to the fourth embodiment of the invention is shown in FIG. 5. Like the camera module in the third embodiment, this camera module includes the wiring substrate 5 having a window portion. The optical tube 12 of the lens unit 1 is attached to the logic circuit portion 22 on the image sensor chip 2. In this example, the optical tube 12 and the wiring substrate 5 are attached together with the underfill 7. The underfill 7 may be applied to all or part of the circumference of the optical tube 12. The camera module has the CSP rewiring layer 3.

The camera module according to this embodiment may be assembled by attaching the image sensor chip 2 to the wiring substrate 5, then mounting the optical tube 12 on the image sensor chip 2, and finally attaching the optical tube 12 and the wiring substrate 5 together. Alternatively, it is also possible to first attach the optical tube 12 to the image sensor chip 2, then insert the tube into the window portion of the wiring substrate 5 from below, and finally attach the optical tube 12 and the wiring substrate 5 together.

The structure of the camera module will be explained in further detail with reference to FIG. 6. In this camera module, the image sensor chip 2 and the DSP chip 6 are mounted to the under surface of the wiring substrate 5 and sealed with sealing resin 8.

There are various methods for electrically connecting the image sensor chip 2 and the wiring substrate 5 as shown in FIG. 6. Among those are using a solder gold bump 91 printed on a pad on the surface of the image sensor chip, using an anisotropic conductive material 92, and using a solder bump formed on the rewiring layer 3.

Further, a spacer may be placed between the image sensor chip 2 and the wiring substrate 5 as shown in FIG. 7. This structure allows maintaining a constant distance between the image sensor chip 2 and the wiring substrate 5, thereby keeping the distance between the lens 11 and the image sensor chip 2 constant.

As described above, the camera module according to the fourth embodiment has a structure where the lens unit is inserted into the window portion of the wiring substrate, thereby achieving further downsizing. Besides, if the structure is configured so that the outer surface of the lens unit contacts the inner surface of the window portion of the wiring substrate, their relative positions can be mutually restricted, allowing easier position determination.

Although the above first to fourth embodiments have explained that the lens unit is composed of the lens and the optical tube, the lens and the optical tube may be integrally formed by resin molding and so on. In this case, the lens unit, except the lens area, is formed with nontransparent material such as black material that allows no light transmission in order to prevent light not transmitted through the lens from entering the image sensor. Alternatively, it is also possible to form the entire body with transparent material and then provide treatment for light blocking such as coating the optical tube area with nontransparent material or covering the area with a tube. The effect of the present invention is the same when the lens area and the optical tube area are integrated. On the other hand, it is also feasible to configure the lens unit and the optical tube to be movable so as to allow focus adjustment of the optical sensor. They are attached to the substrate with adhesives after focusing. Further, though the lens area comprises a single aspherical lens in the above embodiments, it may comprise a plurality of lenses for correction of chromatic aberration and so on. This results in no difference in the effect of the invention.

In addition, the effect of the present invention is the same when the lens unit further has an infrared ray blocking filter for correcting image sensor sensitivity to be close to human eye's sensitivity. Further, the present invention has the same effect when an optical low-pass filter is added in order to prevent image quality deterioration due to sampling operation of the image sensor. Furthermore, the effect stays the same when a diaphragm is provided for restricting the amount of light coming through the lens.

As explained in the foregoing, the present invention can provide a camera module having a reduced size and achieving high focus accuracy.

Industrial Applicability

The camera module according to the present invention is used for mobile phones, personal digital assistants (PDAs), and card cameras.

1. A camera module comprising:
a lens unit comprising a lens and a lens supporting structure for supporting the lens; and
an image sensor chip for processing image signals based on light coming through the lens,
wherein the lens unit is attached to the image sensor chip, and
the image sensor chip comprises a bump for substrate connection in an area outside of an area where the lens unit is mounted.

2. A camera module comprising:
a lens unit comprising a lens and a lens supporting structure for supporting the lens; and
an image sensor chip comprising a sensor portion and a logic circuit portion on one surface thereof for processing image signals based on light coming through the lens,
wherein the lens unit is attached to the logic circuit portion of the image sensor chip.

3. A camera module comprising:
a lens unit comprising a lens and a lens supporting structure for supporting the lens; and
an image sensor chip for processing image signals based on light coming through the lens,
wherein the image sensor chip comprises a chip size package rewiring layer having an optical window, and
the lens unit is attached to the image sensor chip in an area of the optical window.

4. A camera module comprising:
a lens unit comprising a lens and a lens supporting structure for supporting the lens;
an image sensor chip for processing image signals based on light coming through the lens; and
a wiring substrate having a window portion,
wherein the lens unit is attached to the wiring substrate and the image sensor chip in such a way of being inserted into the window portion of the wiring substrate.

5. The camera module according to claim 4, wherein the image sensor chip and the wiring substrate are electrically connected by a solder bump.

6. The camera module according to claim 4, wherein the image sensor chip and the wiring substrate are electrically connected by anisotropic conductive material.

7. A method for manufacturing a camera module, comprising:
a step of attaching a plurality of lens supporting structures for supporting lenses to a wafer comprising a plurality of image sensor chips for processing image signals based on incoming light; and
a step of dicing the wafer having the lenses attached thereto into chip size pieces.

8. A method for manufacturing a camera module according to claim 7, further comprising
a step of inserting a lens of an image sensor chip diced out of the wafer into a window portion of a wiring substrate, and attaching the image sensor chip to the wiring substrate.

9. A method for manufacturing a camera module including a lens unit comprising a lens and a lens supporting structure for supporting the lens, an image sensor chip for processing image signals based on light coming through the lens, and a wiring substrate having a window portion, comprising:
a step of fabricating a camera module in which the lens unit is attached to the image sensor chip; and
a step of inserting and attaching the lens unit of the camera module into the window portion of the wiring substrate.

10. A method for manufacturing a camera module according to claim 9,
wherein the image sensor chip comprises a sensor portion and a logic circuit portion on one surface thereof, and the lens unit is attached to the logic circuit portion.
